(19) United States
(12) Patent Application Publication
(10) Pub. No.: US 2005/0198314 A1
(43) Pub. Date: Sep. 8, 2005

(54) Method and apparatus for characterizing a network connection

(76) Inventors: Tony T. Coon, Menlo Park, CA (US); Lan Tan, San Jose, CA (US); Peter Joseph Henscheid, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/773,649

(22) Filed: Feb. 6, 2004

(51) Int. Cl. G06F 15/16; G06F 15/173

(52) U.S. Cl. 709/228; 709/223

(57) ABSTRACT

A method and apparatus are disclosed herein for characterizing a network connection by receiving network connection parameters, receiving state variable information pertaining to the network connection according to the network connection parameters, sensing when the network connection is initiated according to the state variable information, and storing the state variable information.

### BACKGROUND

Today's communication networks (e.g. the Internet) rely heavily upon packet switching. A communication protocol is a collection of pre-established message structures used by computers that need to convey information to each other. The message structures provided by a communication protocol typically include support for identifying the sender and the recipient of information. Binary information to be transmitted from one computer to another is typically broken up into discrete data units, usually comprising a few thousand bits. The actual information to be transmitted often is referred to as a “payload”. Additional information is usually appended to the payload. This additional information is typically associated with the message structures used by the communication protocol. The payload together with the additional protocol information is often called a “packet”.

A typical communication network is composed of a collection of computers referred to as “nodes.” Computers on a network may be called “clients,” “servers,” or simply “communication processors” depending upon their function. For example, client computers typically are operated by end-users at home or in an office. Servers often take the form of powerful computers that can be accessed by clients using a computer network. Typically, servers have access to information (e.g. sports scores, weather, and the like) that can be requested by a client over the network (e.g. the Internet). Communication processors (e.g., gateways, switches, and routers) operate to manage the flow of data on a network by receiving packets from one computer and forwarding them to another computer. Because the definition of a node encompasses computers operating in different modes (e.g. client computer and server), the terms “node” and “computer” are often used interchangeably.

Communication processors typically include high-performance processing capabilities and are capable of processing packets from thousands of sources every second. As the communication processor operates, each packet is disassembled into its constituent components; payload and protocol information. The protocol information is used to direct the packet as it moves through the computer network. Accordingly, the packet is forwarded according to the protocol information.

Communication protocols generally are defined to include various levels of communications service. For example, one communication protocol, known as the Open System Interconnect (OSI) protocol, defines seven distinct levels of communication service. These seven levels of service are organized in a hierarchical manner, wherein each level of service is dependant on services provided by a subordinate level. The lowest level of service, which consists of the physical medium that actually carries data from one computer to another, has no such subordinate level support. The collection of hierarchical communication service definitions is known ubiquitously as a “stack”. The terms “stack” and “protocol stack” are often used to refer to a collection of software and/or hardware that implement the communication services defined at the various levels in a communication protocol. The collection of software and/or hardware that implement a protocol stack is referred to as a “protocol engine”.

In a stack structured protocol, a data packet commensurate with the communication structure of one level can be enveloped by additional protocol information associated with a lower level in the stack and so on. Accordingly, as data is processed through the protocol stack, various software modules and/or hardware elements work interactively to convey information from one level in the stack to the next. As information moves through the protocol stack, it is augmented with protocol information commensurate with one level before it is passed on to the next level in the stack.

One communication protocol that is in very common use is known as TCP/IP. TCP is an acronym for Transport Control Protocol, a protocol that governs end-to-end communication in a network. TCP defines procedures by which the end-to-end delivery of packets is facilitated through an array of communication nodes distributed throughout a network. The functions of TCP include error detection, retransmission of packets received in error, and providing for the delivery of packets in the proper order. The “IP” part of TCP/IP refers to Internet Protocol, a lower-level protocol that manages the addressing and routing of packets through a network (e.g. the Internet).

Generally, information is conveyed from one computer to another using a network connection. In order to establish a network connection between two nodes, a first node sends a packet comprising a connection request addressed to a second node. The second node receives the request. The second node transmits a response to the first node. The first node receives the response to the request, and a network connection is established. The first and second nodes thereafter may exchange information over the network connection, using packets that contain information about the connection in their protocol bits, until the network connection is terminated.

The definitions constituting communication protocols have continued to evolve with the ever-increasing demand for network-based communication services. And, whenever the definition of a communication protocol changes, the software modules and/or hardware elements that implement that definition must also be modified. These software modules and/or hardware elements are extremely complex and revision to their design carries the risk of inaccurate implementation of associated protocol definitions. New designs are even more susceptible to these risks. Designers need facilities for observing the operation of a computer network and the operation of software modules and/or hardware elements that implement a protocol stack. Such observation is essential to assure that new or revised implementations conform to the definitions of the protocol stack.

In the past, information about network and protocol stack operation was gathered by monitoring packets as they were communicated across a network from one computer to another. The packets could then be analyzed in detail. This technique results in data known as “packet traces.” Packet traces, then, comprise recordings of packets transmitted and received at a node. By inspecting the protocol information contained in sequentially transmitted and received packets, there is a potential for identifying some types of errors in the implementation of a protocol stack. Unfortunately, packet traces do not permit determination of all pertinent information about a given connection.

### SUMMARY

A method and apparatus are disclosed herein for characterizing a network connection by receiving network connection parameters, receiving state variable information pertaining to the network connection according to the network connection parameters, sensing when the network connection is initiated according to the state variable information, and storing the state variable information.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram of a representative embodiment of a method for characterizing a network connection;

FIG. 2 is a table that illustrates a representative embodiment of a report that characterizes the history of a network connection;

FIG. 3 is a flow diagram of a representative embodiment of a method for receiving state variable information;

FIG. 4 is a flow diagram of a representative embodiment of a method for characterizing the history of a network connection;

FIG. 5 is a flow diagram of a representative embodiment of a method for evaluating a network connection;

FIG. 6 is a flow diagram of a representative embodiment of one alternative method for characterizing a network connection;

FIG. 7 is a flow diagram of a representative embodiment of a method for creating a dynamic profile;

FIG. 8 is a block diagram of a representative embodiment of a network connection analysis unit;

FIG. 9 is a pictorial diagram of a representative embodiment of a dynamic profile;

FIG. 10 is a block diagram of a representative embodiment of a supervisor;

FIG. 11 is a block diagram of a representative embodiment of a state variable manager;

FIG. 12 is a block diagram of a representative embodiment of an off-line connection analysis unit;

FIG. 13 is a block diagram of a representative embodiment of a report generator;

FIG. 14 is a block diagram of a representative embodiment of a real-time connection analysis unit;

FIG. 15 is a block diagram of a representative embodiment of a dynamic profile generator; and

FIG. 16 is a block diagram of a representative embodiment of a network connection analysis system.

### DETAILED DESCRIPTION

One effective and accurate way to characterize the operation of a protocol engine operating in a node is to discover its “state variables”. State variables describe the condition of the protocol stack at a particular instant in time. Typically, a protocol engine maintains a set of state variables for each active network connection; noting that a network connection is a conduit between two computers (or nodes) attached to a computer network and that the two computers can communicate using the network connection. By gathering packet traces, the values of some state variables can be inferred, but these inferences are not always correct. Protocol engines have been implemented for a wide variety of protocol definitions. For example, there are many protocol engines that implement the TCP/IP protocol. Disclosed herein is a method for characterizing a network connection by directly receiving state variables from a protocol engine according to parameters that describe a connection. Also disclosed are various apparatus that embody the method.

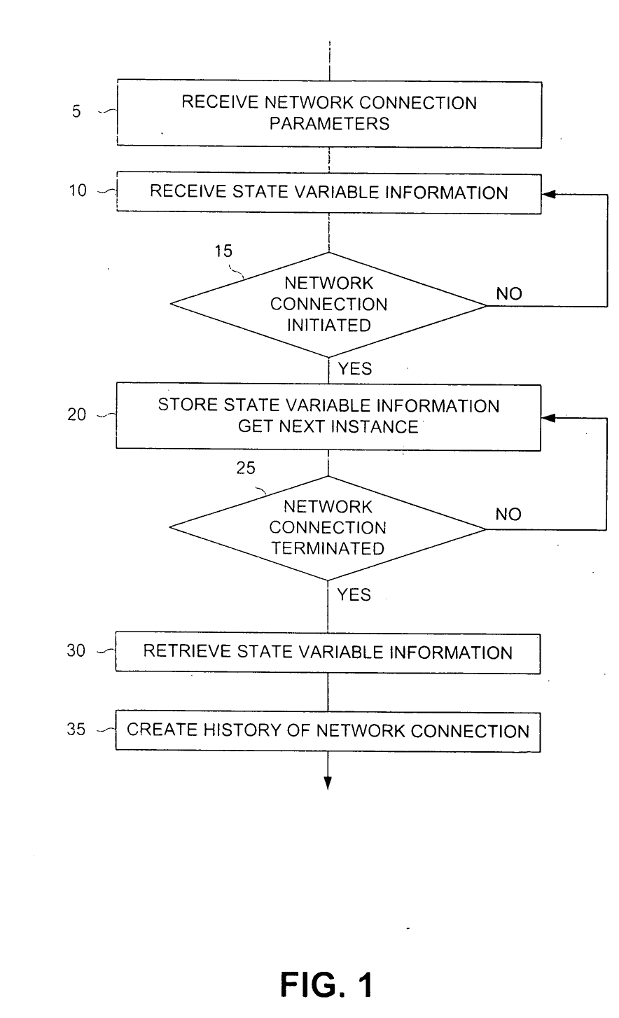

FIG. 1 is a flow diagram of one example method for characterizing a network connection. According to this example method, parameters that specify a network connection are received (step 5). According to one illustrative variation of the method, the network connection parameters are received from a user who needs to observe the operation of a protocol engine. Such a user may include a designer that needs to characterize a particular network connection as the implementation of a protocol engine is evaluated.

When the TCP/IP protocol is used to communicate between two nodes, the network connection established between the two nodes is often referred to as a “TCP connection”. A TCP connection is characterized by four numbers relating to the first and second. Each computer on a network has associated with it an IP address. The IP address is a 32-bit binary number normally formatted as four 8-bit binary numbers expressed in decimal form. One example of an IP address, which is presented here for illustrative purposes only, is “10.32.46.2”. In many cases, each computer on a network also has associated with it a set of ports. A port can be visualized as a logical channel through which packets can flow to and from the computer. A TCP connection between two nodes (or computers) is accordingly characterized by four numbers comprising 1) the IP address of a first node, 2) a port number on the first node, 3) the IP address of a second node, and 4) a port number on the second node. These four numbers can be written as (first IP address, first port number, second IP address, second port number) in a form referred to as a 4-tuple. One example of a 4-tuple that identifies a TCP connection is (10.32.46.2, 80, 20.127.0.16, 25). That is, a 4-tuple that describes a network connection between a port 80 on a computer having IP address 10.32.46.2 and port 25 on a computer having IP address 20.127.0.16. This 4-tuple comprises an example of what may be referred to as network connection parameters and is presented as a non-limiting illustration. It should also be noted that the IP address is a logical address used to identify a computer attached to a computer network and is only one example of an addressing scheme that is used to identify computers in this manner and is not intended to limit the scope of the appended claims.

According to another illustrative variation of the present method, the connection parameters comprise one or more of a protocol identifier, an address and a port number. The protocol identifier is typically used to identify what type of protocol has been used to establish a network connection. A protocol identifier can also be used to identify at which layer in a protocol a connection is established. The address parameter is used to identify a particular logical address through which a network connection has been established; either for a source or destination node. The port number parameter is used to identify which port in the logical address is servicing the network connection; again, either source or destination node. According to yet another variation of the present method that is applicable where a network connection has been established using the TCP/IP protocol, network connection parameters comprise four numbers that uniquely specify a TCP connection between two nodes. These four numbers comprise an IP address and port number for a first node and an IP address and port number for a second node. Again, this is known as a 4-tuple.

The present method further comprises receiving state variable information (step 10) pertaining to the network connection according to the network connection parameters. Table 1 lists one example set of state variables that are received according to one example protocol, TCP.

TABLE 1

| TCP STATE | TCP STATE |
|---|---|
| VARIABLE | VARIABLE |
| NAME | MEANING |
| DST | Host Address of Destination |
| SNXT | Next Sequence Number To Send |
| SUNA | Unacknowledged Sequence Number |
| SWND | Send Window (Relative To SUNA) |
| CWND | Congestion Window |
| RNXT | Sequence Number We Expect To Receive Next |
| RACK | Sequence Number We Have Acknowledged |
| RWND | Current Receive Window |
| RTO | Round Trip Timeout |
| MSS | Maximum Segment Size |
| LPORT | Source Port |
| FPRT | Destination Port |
| STATE | State of the Connection |

According to the present method, the initiation of a network connection associated with the network connection parameters is sensed (step 15) by observing the state variables. According to one illustrative example, monitoring the value of the “STATE” state variable determines whether a TCP connection is active. However, the actual state variable or set of state variables that are monitored in order to determine if a network connection is initiated can vary according to the type of protocol and according to particular implementations thereof and the scope of the appended claims is not intended to be limited to any examples heretofore presented. State variables associated with the network connection are stored (step 20) while the connection is active. According to one variation of the present method, state variables are stored in a computer-readable medium, such as memory or a hard disk. According to one alternative variation of the present method, an instance of state variables is stored on a periodic basis, for example, at rate of ten times per second. According to one alternative example method, a time stamp is associated with each instance of state variables stored. Note that this is exemplified in the figure by step 20 wherein the step of storing state variables impliedly retrieves the next instance of state variables.

Further monitoring of the state variables permits sensing of the termination of the network connection (step 25). According to one example variation of the present method that is applicable to monitoring state variables where a network connection has been established using the TCP/IP protocol, the STATE state variable is monitored in order to determine when a connection is terminated. Again, different state variables will be used when monitoring the state of a network connection established under different protocols and the scope of the claims appended hereto is not intended to be limited to applications where the TCP/IP protocol is used to establish a network connection.

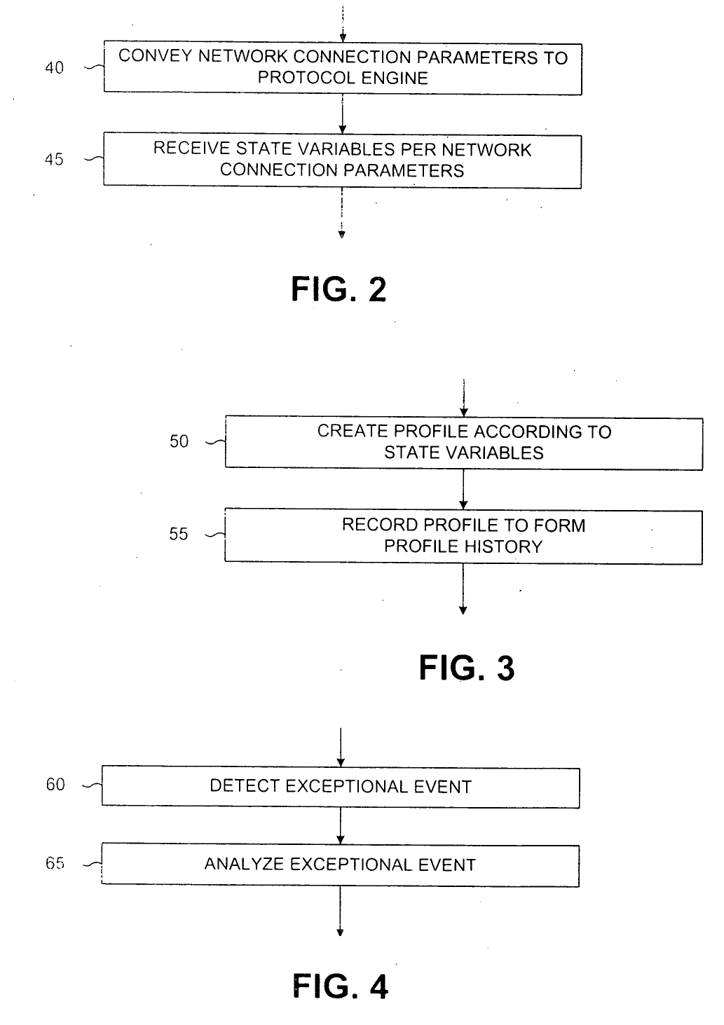

FIG. 2 is a flow diagram of one illustrative variation of the present method for receiving state variable information. According to one example variation of the method, the state variable information is received from a protocol engine. According to this variation of the present method, network connection parameters are conveyed to the protocol engine (step 40). State variables are then received from the protocol engine according to the network connection parameters (step 45). One known embodiment of a protocol engine is implemented in software and is included in the operating system of a computer. For example the Linux® and FreeBSD® operating systems, which are closely related to the UNIX® operating system, include such a protocol engine. (Linux is a registered trademark of Linus Torvalds. FreeBSD is a registered trademark of Wind River Systems, Inc. UNIX is a registered trademark of The Open Group in the United States and other countries.) According to another exemplary variation of the present method, a snap-shot command (e.g. a Unix “ioctl” command, or any equivalent thereof) is used to cause an operating system to fill a buffer with current values of the state variables. According to yet another example variation of the present method, the snap-shot command is issued periodically. An updated copy of the state variables is received each time snap-shot command is issued.

FIG. 1 further illustrates that, according to one alternative example method, state variables that are stored are retrieved (step 30) after the connection terminates. According to one representative variation of the present method, the state variables are retrieved sequentially in the order in which they were stored. According to yet another alternative method, state variables are retrieved along with an associated time stamp. In this case, the time stamp can be used to establish the chronological sequence of the state variables. Analysis of the state variables once properly sequenced, according to yet another alternative example method, results in a history of the network connection (step 35). According to another representative variation of the present method, the history of a network connection is characterized by generating a report depicting the state of a selected set of state variables during the life of the connection.

FIG. 3 is a flow diagram of a representative method for creating a history of a network connection. By analyzing successive instances of state variables associated with a connection over time, a profile indicative of one aspect of a network connection can be created (step 50). For example, according to one illustrative use case wherein the present method is applied to observation of a TCP connection, the present method is used to analyze the behavior of the RWND (Current Receive Window) variable. When the RWND state variable, if normally exhibiting a high value, momentarily drops to a low value, it indicates that a remote node momentarily became too busy (suggested by the low value of RWND) to continue to receive packets. This profile is indicative of one aspect of the network connection, i.e. the state of activity of the remote node. The profile is recorded (step 55) in order to form a history of the profile indicative of one aspect of the network connection.

Analysis of the exemplary list of state variables in Table 1 can provide useful information about a TCP connection. According to one illustrative example, the CWND (Congestion Window) variable provides an indication of network congestion. A large value of CWND implies a low level of network congestion while a smaller value of CWND suggests that the network is more congested. A network device operating according to TCP adaptively adjusts its value of CWND according to observations of such events as the time required to receive confirmation of receipt of a transmitted packet. According to another illustrative example, the RNXT (Sequence Number We Expect To Receive Next) and RACK (Sequence Number We Have Acknowledged) variables provide an indication of whether the node wherein the protocol engine resides (i.e., the local node) is receiving packets on a consistent and timely basis. These exemplary uses of TCP state variables are included for illustration only and are not intended to limit the scope of the appended claims.

FIG. 4 is a flow diagram of an alternative method for creating a history of a network connection. According to this alternative method, creating a history of a network connection profile is augmented by detecting an exceptional event (step 60). One alternative variation of the method further provides that an exceptional event is analyzed when it is detected (step 65). This exceptional event may be analyzed using a simple rules-based technique. One example of an exceptional event occurs in a TCP use case where the value of CWND trends upward and then suddenly drops to a small number. Using a simple rule-based inference, this behavior would result in an inference that packets may have been lost or received out of order. TCP, for example, is known as an adaptive protocol. That is, TCP provides procedures to recover from a wide variety of anomalous network conditions. One particularly useful example occurs when the protocol engine reacts incorrectly to an exceptional event by performing actions that violate the dictates of TCP. Discovering such erroneous responses to exceptional events permits correction of errors in the software and/or hardware in a protocol engine that implements a protocol stack.

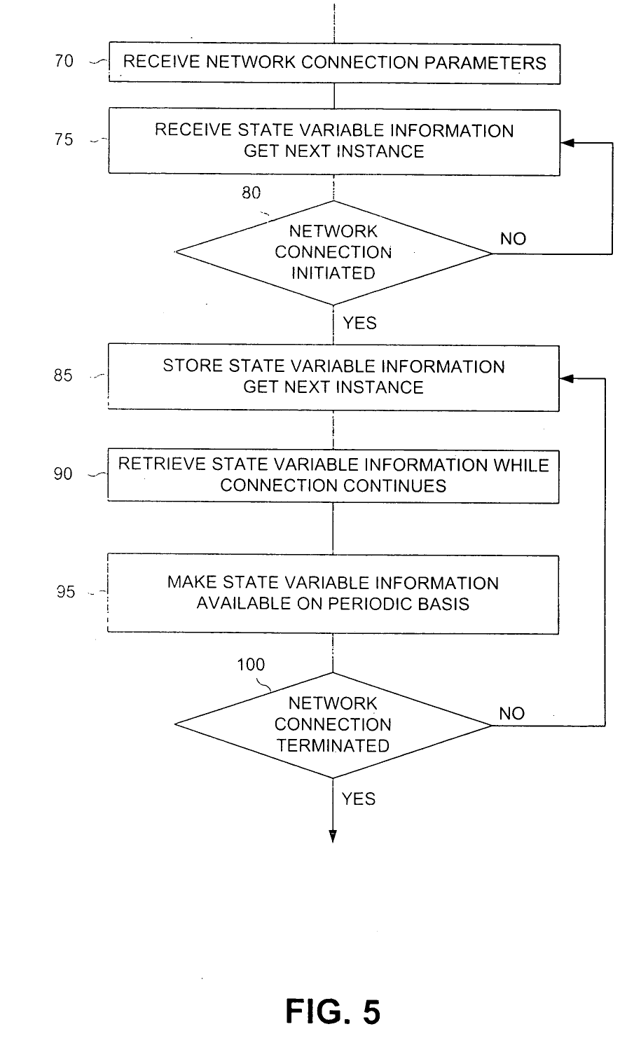

FIG. 5 is a flow diagram that depicts one alternative method for characterizing a network connection in substantially real-time. According to this alternative method, network connection parameters are received as described supra (step 70) and state variables are received (step 75) according to the network connection parameters. When a connection is initiated (step 80), state variables are stored and a new set of state variable are retrieved (step 85). Again, the state variables, according to one variation of the method, are retrieved on a periodic basis. According to this alternative method, state variables are retrieved (step 90) while the connection continues, e.g. has not terminated (step 100). The state variable are made available on a periodic basis (step 95), e.g. by displaying the state variables on a diagnostic terminal. Additional instances of the state variables are also received and stored (step 85) while the connection continues.

When this variation of the present method is used to observe a network connection established using the TCP/IP protocol, state variables can be selected from, among others, SNXT (Next Sequence Number To Send) and SUNA (Unacknowledged Sequence Number). The value of these variables is plotted against time on a graphical display according to one variation of this method. A user may infer whether a remote node is receiving packets on a consistent and timely basis by observing the difference on a screen between the values of SNXT and SUNA. Again, these selected state variables and their interpretation pertain to connections established using the TCP/IP protocol and these examples are not intended to limit the scope of the appended claims. The true spirit of the appended claims in intended to include all variations of state variable, the selection of which will vary depending on the type of protocol and a particular implementation thereof.

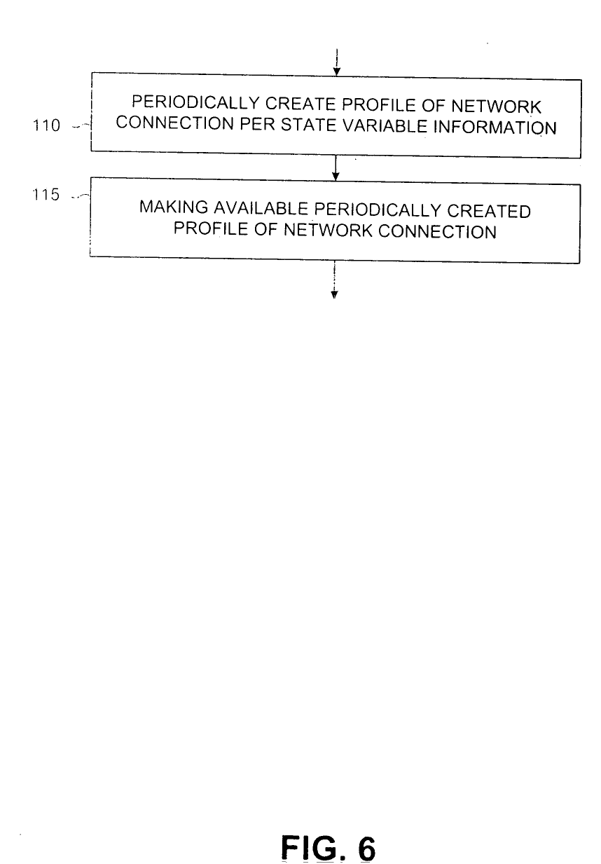

FIG. 6 is a flow diagram that depicts one example alternative method for making a state variable available while the connection continues. According to this alternative method, a state variable is retrieved and used as the basis of a profile (step 110). The profile is created on a periodic basis. The profile is created in a manner so as to indicate a particular aspect of the network connection, as described supra. The profile is then made available on a periodic basis (step 115), for example by displaying the profile on a display. One example method of making the results of the periodic evaluation available is to display the results in graphical form on a display device.

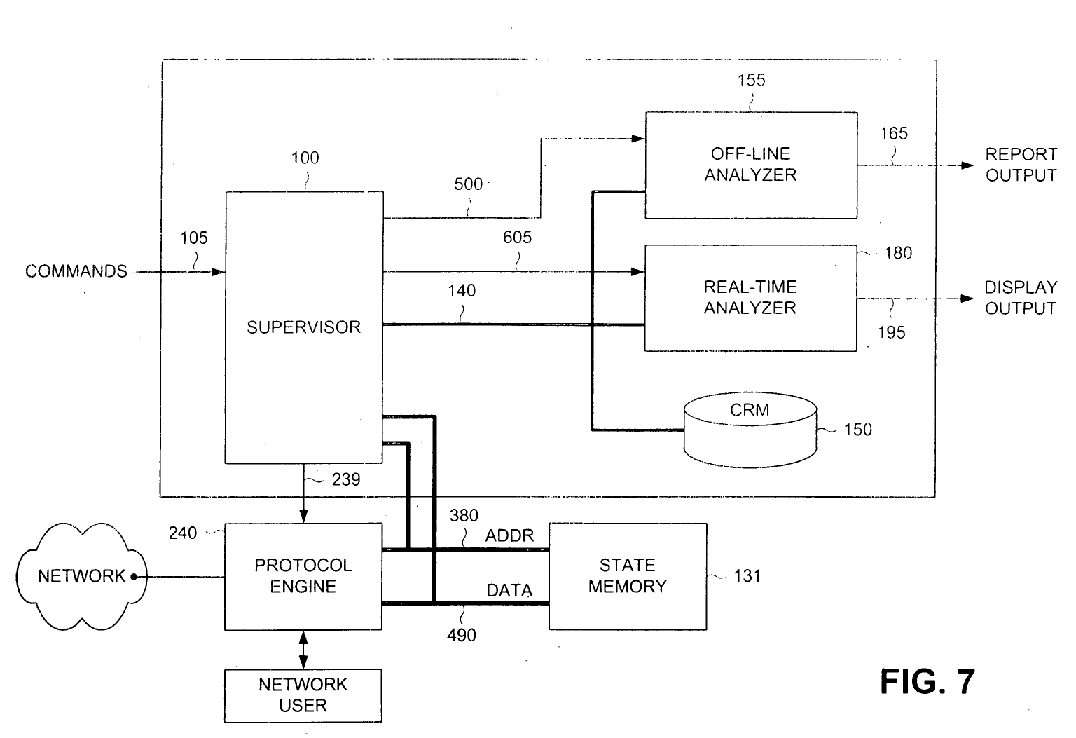

FIG. 7 is a block diagram of a representative embodiment of a network connection analysis unit. This example embodiment comprises a supervisor 100. According to one alternative embodiment, the network connection analysis unit further comprises an off-line analyzer 155. The off-line analyzer 155 makes results available as a report 165. According to yet another alternative embodiment, the network connection analysis unit further comprises a real-time analyzer 180. The real-time analyzer makes results available as a display output 195.

In operation, the supervisor 100 interacts with a protocol engine 240 by sending a request 239. According to one alternative embodiment, the request includes a connection specifier, which will be described infra. In response to the request 239, the protocol engine 240 provides state variables according to a connection specifier back to the supervisor 100. According to yet another alternative embodiment, the protocol engine 240 provides state variables by providing a reference to the supervisor 100. The supervisor 100 uses the reference to access a state memory 131. Using the reference as a basis for a memory address 380, the supervisor 100 retrieves state variables from the state memory 131 using a data bus 490. As the supervisor 100 retrieves state variable, the supervisor directs the state variables to a computer readable medium 150. The computer readable medium 150, according to one alternative embodiment, comprises at least one of random access memory and rotating media.

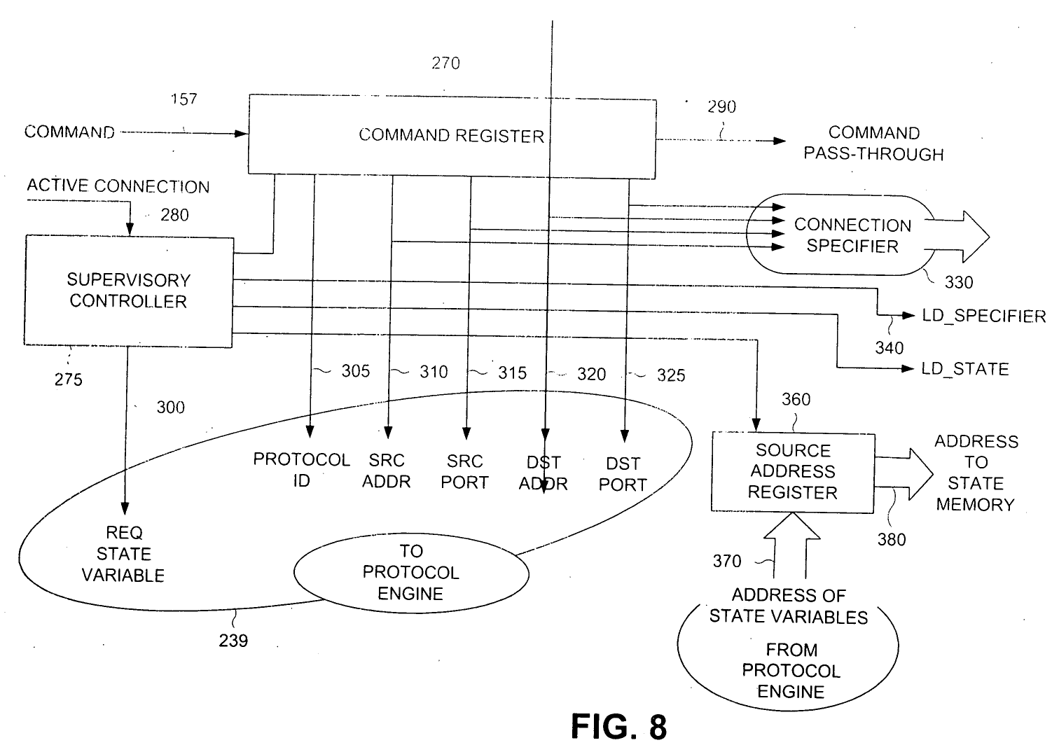

FIG. 8 is a block diagram that depicts one exemplary embodiment of a supervisor. According to this exemplary embodiment, a supervisor 100 includes a supervisory controller 275 and a command register 270. The command register 270 is capable of receiving a command 157 that includes connection parameters that specify a network connection. Once a command is received, the supervisory controller 275 determines if the command is addressed to the supervisor 100. If it is not addressed to the supervisor 100, the command is passed through using a pass-through path 290 included as an output from the command register 270. When a recognized command is received by the command register 270, the supervisory controller 275 generates a request signal 300. The request signal is directed to the protocol engine 240. In addition to the request signal 300, the command register, according to one alternative embodiment of a supervisor 100, generates a connection specifier 330 that includes at least one of a protocol identifier 305, a source address 310, a source port 315, a destination address 320 and a destination port 325. Any of these may be constituent components of connection parameters included in the command 157 received by the command register 270.

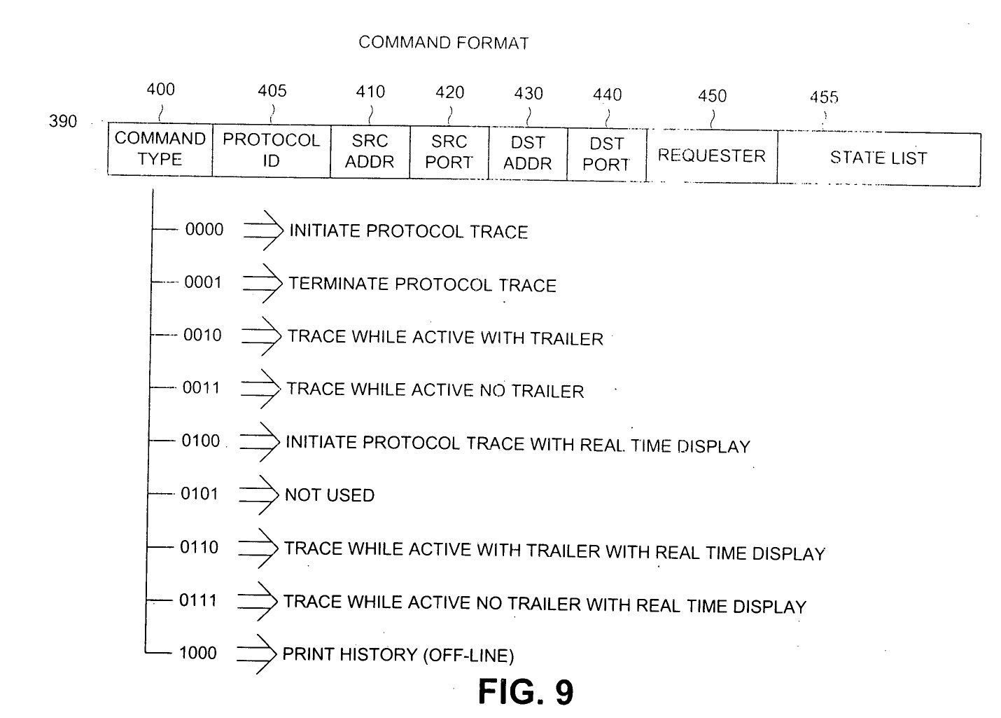

FIG. 9 is a pictorial representation of an exemplary command format. According to one alternative embodiment of a supervisor 100, the command register 270 receives a command 390 that includes a command type field 400. The command type field 400 is used to define a type of command. For example, command types supported by one alternative embodiment include, but are not limited to:

| TYPE | COMMAND NAME |
|---|---|
| 0000 | Initiate protocol trace; |
| 0001 | Terminate protocol trace; |
| 0010 | Trace while active with trailer; |
| 0011 | Trace while active no trailer; |
| 0100 | Initiate protocol trace with Real Time Display; |
| 0101 | Not Used; |
| 0110 | Trace while active with trailer and Real Time Display; |
| 0111 | Trace while active no trailer with Real Time Display. |
| 1000 | Print History (Off-Line) |

In the case of these exemplary command types, the trace commands are recognized by the supervisor 100 as requests to initiate a trace of protocol engine state variables. When a trailer is requested, the supervisor 100 continues to accumulate state variables after a connection terminates. When a trace is requested with Real Time Display, the supervisor 100 not only responds to the command by initiating a trace, it also passes the command along to the real time analyzer 180. The print history command is not recognized by the supervisor 100 and is passed along to the off-line analyzer 155.

FIG. 8 further illustrates that one example embodiment of a supervisor 100 further comprises a source address register 360. According to this embodiment, the source address register 360 receives an address 370 that points to state variables maintained by the protocol engine 240. The source address 380 is driven by the source address register 360 in order to retrieve a state variable from the state memory 131.

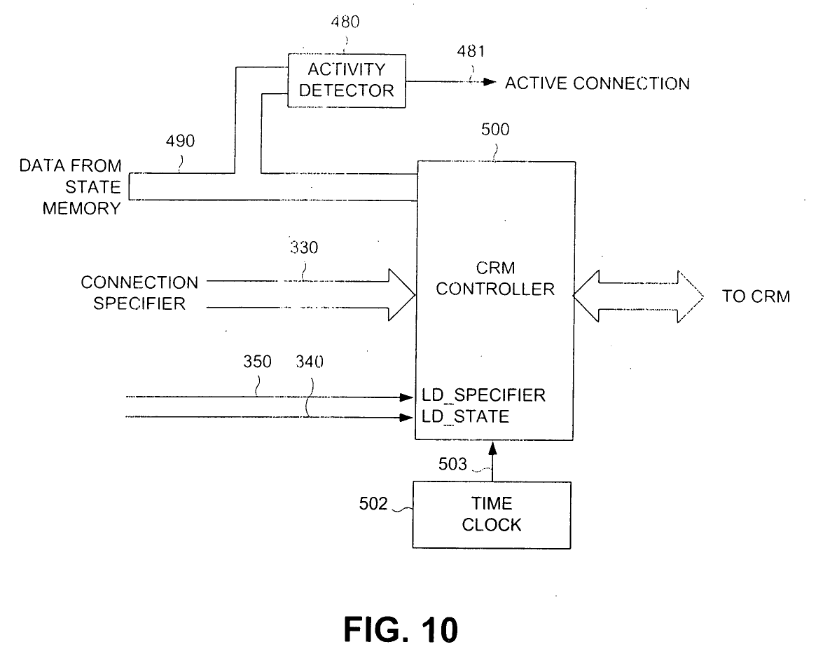

FIG. 10 is a block diagram showing additional elements of one exemplary embodiment of a supervisor. According to one embodiment, the location in the state memory referenced by the source address 380 contains a state variable that is indicative of the state of the connection specified by the connection specifier 330 provided to the protocol engine 240. When the state variable indicates that the connection is active, the supervisory controller 275 generates a load specifier signal (LD_SPECIFIER) 340. It should be noted that one embodiment of the supervisor includes an activity detector 480 that monitors the state variable received from the state memory 131 by the data bus 490. The activity detector 480 generates an active connection signal 481 when the state of the state variable indicates that the connection is active. According to one alternative embodiment that is useful for monitoring a connection established using the TCP/IP protocol, the activity detector. This exemplary embodiment further comprises a computer readable medium controller 500 that receives a connection specifier 330 from the command register 270. According to one alternative embodiment, the supervisor 100 further comprises a time clock 502. According to this alternative embodiment, the computer readable medium controller 500 retrieves a time stamp 503 when it receives the connection specifier 330 and appends it to the connection specifier 330.

As the supervisory controller 275 continues to operate, it causes the source address register 360 to increment to the next state variable. Substantially concurrent with this, the supervisory controller 275 issues a load state (LD_STATE) signal 350. In response to the LD_STATE signal 350, the computer readable medium controller 500 receives a state variable from the state memory 131 via the data bus 490 as addressed by the source address register 360. A terminal count signal is issued to the computer readable medium controller 500 when the last state variable is received for a particular time instance.

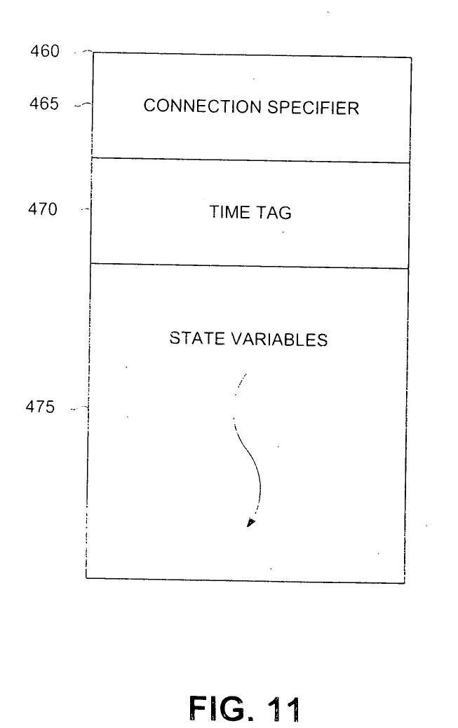

FIG. 11 is a pictorial representation of a state variable packet stored on computer readable medium. According to one embodiment, the computer readable medium controller 500 generates a state variable packet 460 when it receives a terminal count signal. According to this embodiment, the state variable packet includes a connection specifier 465 and values for one or more state variables 475. According to one alternative embodiment, the state variable packet 460 further includes a time tag 470. This time tag represents the value read from the time clock 502 when the computer readable medium controller 500 receives a LD_SPECIFIER signal 350. The computer readable medium controller 500 directs the state variable packet 460 to computer readable medium using a medium bus 200. The medium bus, according to one alternative embodiment, comprises at least one of a small computer systems interface bus and an integrated device electronics interface.

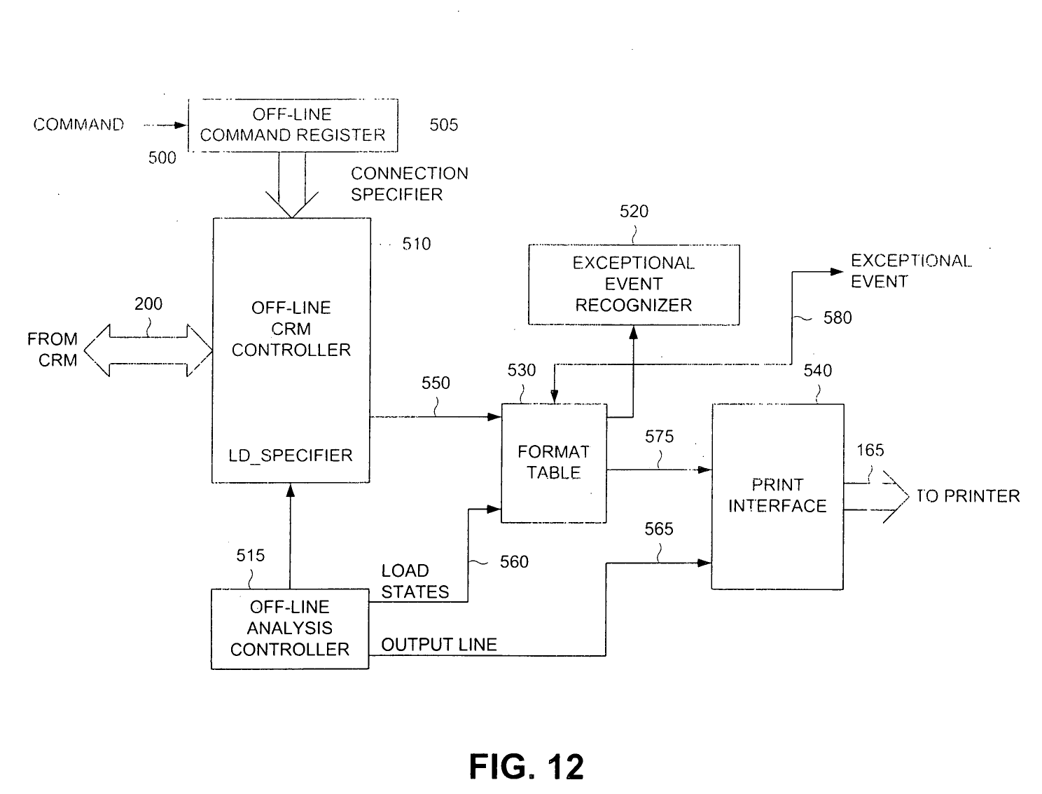

FIG. 12 is a block diagram of one example embodiment of an off-line analyzer. According to this example embodiment, an off-line analyzer 155 comprises an off-line command register 505, an off-line computer readable medium controller 510 and an off-line analysis controller 515. When the off-line command register 505 receives a request for off-line analysis (e.g. the print command type described in FIG. 9), the off-line command register 505 provides a connection specifier to the off-line computer readable medium controller 510. It should be noted that the command typically includes the connection specifier. Using the connection specifier, the off-line computer readable medium controller 510 retrieves state variable information from the computer readable medium 150. According to one alternative embodiment, the state variable information is retrieved in the form of state variable packets 460 selected according to the connection specifier stored therein. According to yet another embodiment, the off-line computer readable medium controller 510 uses a time tag in the state variable packet 460 to organize state variable chronologically.

The off-line analysis controller 515 generates a load states signal 560 when state variable information is available in the off-line computer readable medium controller 510. State variables 550 are directed to a format table 530 includes in one alternative embodiment of an off-line analyzer 155. The format table 530 organizes the state variables into a print stream using a pre-established report format. According to one alternative embodiment, the format table 530 includes a profile description that describes the organization of one or more state variables into a connection profile. One alternative embodiment of an off-line analyzer 155 further comprises an exceptional event recognizer 520. The exceptional event recognizer 520 monitors a formatted output of state variables from the format table 530. The exceptional event recognizer then generates an exceptional event signal 580 back to the format table 530. When the format table receives an exceptional event signal 580, it alters the format of the print stream 575 it generates. For example, one alternative embodiment of the format table selects a new format for a report when an exceptional event is detected.

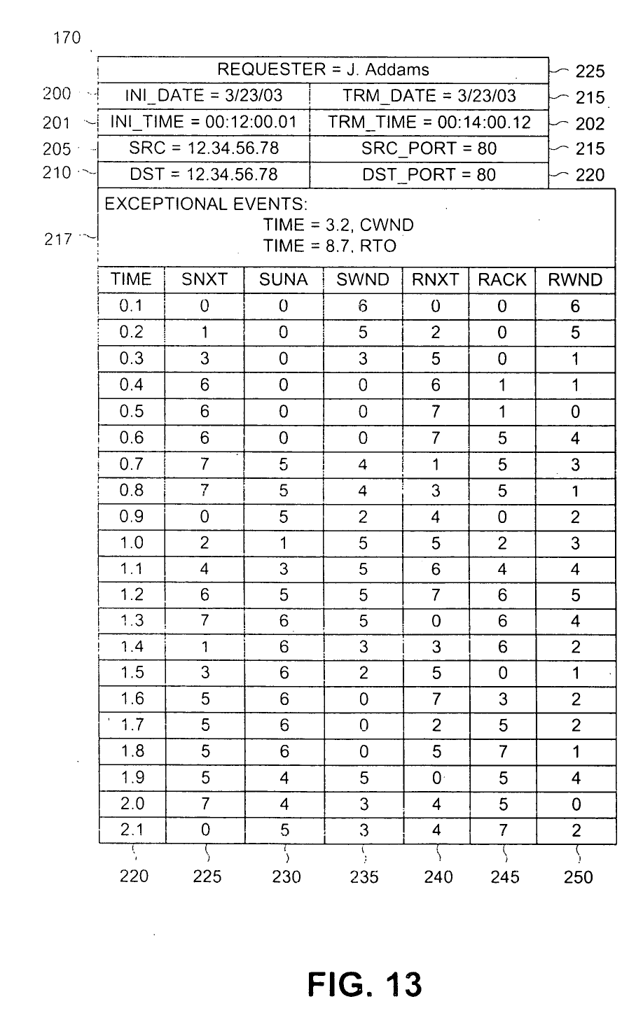

FIG. 13 is a pictorial representation that illustrates one example embodiment of a report that can be used to present history of a network connection. This example report embodiment 170 enumerates values of several state variables at each of a plurality of time instances. This type of format is generally embodied in the format table 530 included in the off-line analyzer 155. The state variables are acquired according to the example method described heretofore. According to this example embodiment, a report 170 comprises fields for presenting summary information about a connection. According to one alternative example embodiment, summary information comprises at least one of a date on which the connection was initiated 200, a time at which the connection was initiated 201, a date on which the connection was terminated 215, a time at which the connection was terminated 202, an address of a source node 205, a port number of the source node 215, an address of a destination node 210, a port of the destination node 220 and the name of a person 225 that requested the report.

This example embodiment of a report 170 comprises a column 220 for time (e.g. in seconds) measured from the initiation of the connection. The report 170 still further comprises columns for a selected set of state variables. The sample set of state variables is typical of a set of state variables used to represent the state of a connection established using the TCP/IP protocol. Hence, columns include SNXT (Next Sequence Number To Send) 225, SUNA (Unacknowledged Sequence Number) 230, SWND (Send Window) 235, RNXT (Sequence Number We Expect To Receive Next) 240, RACK (Sequence Number We Have Acknowledged) 245, and RWND (Receive Window) 250. The columns presented here illustrate one example embodiment of a report 170 and the selected set of state variables presented in the figure is not intended to limit the scope of the appended claims.

Each row of the columns (225, 230, 235, 240, 245, 250) is used to present the contents of a state variable packet 460, wherein each state variable packet 460 is used to store a set of state variables at a particular instance in time. The chronological sequence and the time at which the state variables were stored relative to the initiation of a network connection is represented by values of time presented in the time column 220. One alternative embodiment of a report 170 further comprises an EXCEPTIONAL EVENTS field 217 that calls attention to unexpected or surprising occurrences observed during the connection. This field is typically included in the report when the format table 530 receives an exceptional event signal 580 from the exceptional event recognizer 520. It should be noted that the set of state variables selected, any values of the selected state variables and any chronological graduations are presented in the figure for illustration purposes only and are not intended to limit the scope of the appended claims.

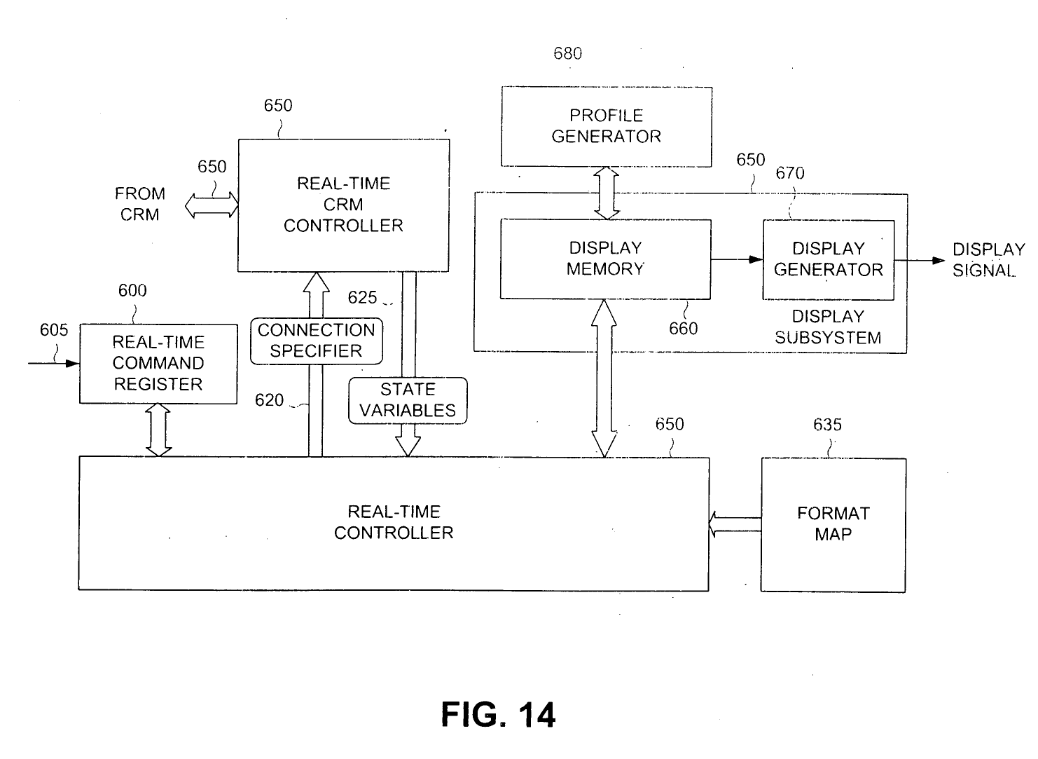

FIG. 14 is a block diagram of a representative embodiment of a real-time connection analyzer. According to this representative embodiment, a real-time connection analyzer 180 comprises a real-time command register 600, a real-time controller 610 and a real-time computer readable medium controller 650. When a command is received by the real-time command register 600, a connection specifier is directed to the real-time controller 610. The real-time controller 610 directs the connection specifier 620 to the real-time computer readable medium controller 650. In response, the real-time computer readable medium controller 650 retrieves state variables from the computer readable medium 150. According to one alternative embodiment, the real-time computer readable medium controller 650 retrieves state variable packets 460 that have a connection specifier equal to the connection specifier received from the real-time controller 610. According to one alternative embodiment, the real-time computer readable medium controller 650 uses a time tag included in the state variable packets 460 to organize state variables chronologically.

The real-time computer readable medium controller 650 provides to the real-time controller 610 successive instances of state variables 625 for a connection identified by the connection specifier 620. The real-time controller 610 uses a format map 635 included in this example embodiment of a real-time analyzer 180 to determine how to format the state variables 625. This example embodiment further comprises a display subsystem 650. According to one alternative embodiment, the display subsystem 650 comprises a display memory 660 and a display generator 670. The display generator 670 generates a display signal suitable for driving a display (e.g. a video signal, a digital video signal or a liquid crystal display drive signal). The display generator 670 generates the display signal based on data stored in the display memory. Formatted state variables are placed into the display memory 660 by the real-time controller 610. According to one alternative embodiment, the display subsystem 650 further comprises a profile generator 680. The profile generator 680 correlates one or more state variable stored in the display memory with a particular network profile. Once this type of correlation is accomplished, the profile generator 680 places information pertaining to the profile into the display memory 680. The display generator 670 generates a display signal based on the profile placed in the display memory 670 by the profile generator 680.

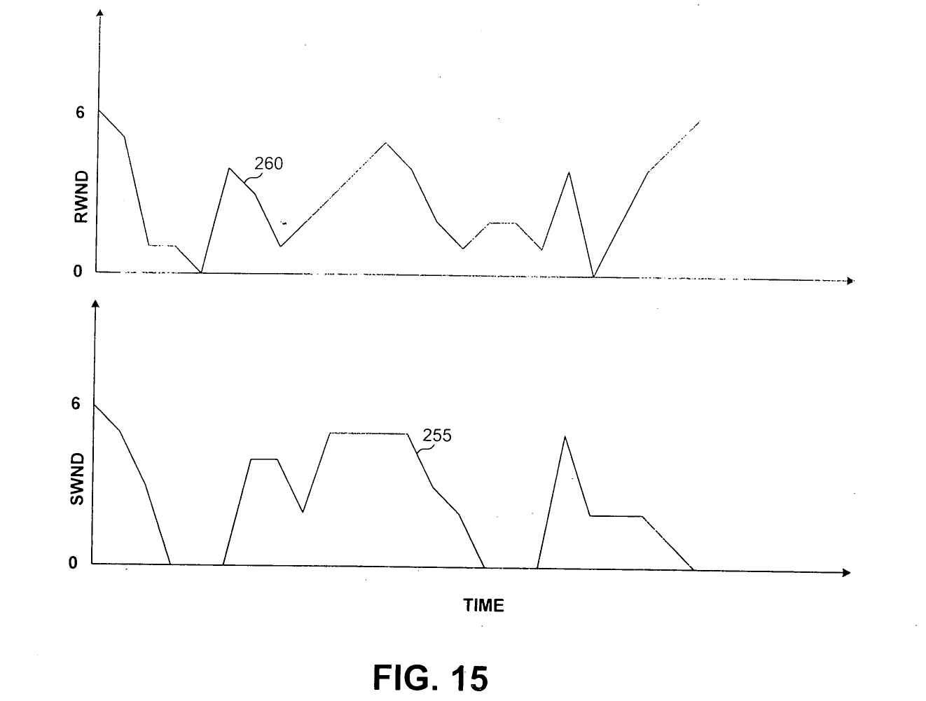

FIG. 15 is a pictorial representation of a real-time display. As the real-time controller 610 included in the real-time analyzer 180 continues to operate, it receives a plurality of values for a particular state variable at different instances in time from the real-time computer readable medium controller 650. Hence, a plurality of values are presented to a user using a time plot. The format map 635 provides information with respect to scaling a value of a particular state variable with respect to the number of time plots that must be simultaneously displayed. For example, in one particular embodiment that is useful in presenting state variables from a protocol engine wherein a connection has been established using the TCP/IP protocol, state variables SWND (Send Window) 255 and RWND (Receive Window) 260 are simultaneously presented. The format map 635 scales the values for these two state variables so that a time plot can be fit into an available display size. These state variable are presented here to illustrate one embodiment and are not intended to limit the scope of the appended claims. According to one alternative embodiment, a time plot comprises a sliding window of selected state variables as they vary with time while a connection is active. As additional values for a state variable are received, the real-time controller 610 moves the formatted and scaled state variables in the display memory 660 to result in a sliding window.

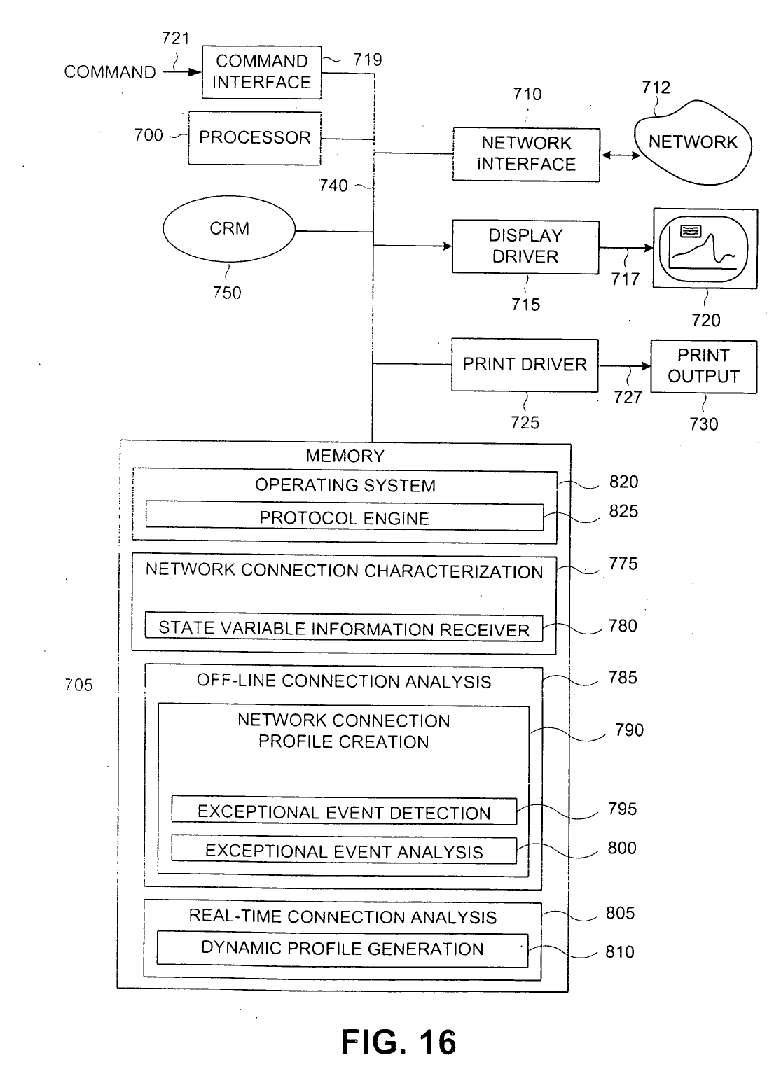

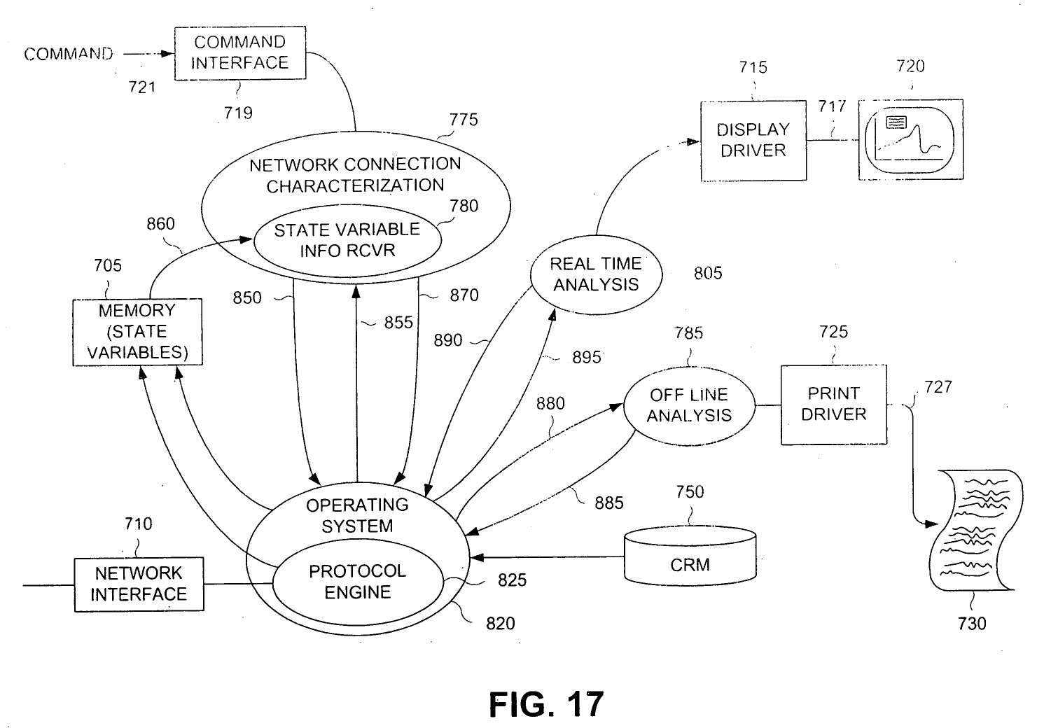

FIG. 16 is a block diagram of a representative embodiment of a network connection analysis system. This embodiment comprises one or more processors 700 and a memory 705. According to one alternative embodiment, the network connection analysis system further comprises a command interface 719. The command interface is capable of accepting a command 721. According to yet another alternative embodiment, the network connection analysis system further comprises a network interface 710. The network interface is capable of communicated data to and received data from a data network 712. According to yet another alternative embodiment, the network connection analysis system further comprises a computer readable medium 750. The computer readable medium can include, but is not limited to rotating medium and random access memory. According to yet another alternative embodiment, the network connection analysis unit further comprises a display driver 715, which is capable of driving a display device 720. According to yet another alternative embodiment, the network connection analysis unit further comprises a print driver 725 which is capable of driving a printer 730. A system bus 740 interconnects any and all of the aforementioned elements.

According to this exemplary embodiment, the network connection analysis system further comprises a network connection characterization instruction sequence 775 that, when executed by the processor 700, minimally causes the processor 700 to receive parameters that specify a network connection, receive state variable information pertaining to the network connection according to the received parameters, sense when the network connection is initiated according to the received variable state information and store the state of the variable information.

This example embodiment further comprises various functional modules each of which comprises an instruction sequence. For purposes of this disclosure, a functional module and its corresponding instruction sequence is referred to by a process name, a function name or a module name. For example, the aforementioned network connection characterization instruction sequence 775 can be referred to as the network connection characterization process, function or module. The instruction sequence that implements the process name, according to one alternative embodiment, is stored in the memory 705. The reader is advised that the term “minimally causes the processor” and variants thereof is intended to serve as an open-ended enumeration of functions performed by the processor as it executes a particular functional process (i.e. instruction sequence). As such, an embodiment where a particular functional process causes the processor to perform functions in addition to those defined in the appended claims is to be included in the scope of the claims appended hereto.

According to one alternative embodiment, the network connection characterization instruction sequence 775 includes a state variable information receiver instruction sequence 780. According to an alternative illustrative embodiment, the network connection analysis system further includes an off-line connection analysis instruction sequence 785. According to yet another alternative embodiment, the network connection analysis system further includes an real-time connection analysis instruction sequence 805. It should be noted that one alternative embodiment further comprises an operating system 820 that includes a protocol engine 825. Accordingly, the protocol engine 825 is capable of sending a receiving data across a network 712 using the network interface 710. The operating system 820 is also capable of managing the storage of data on the computer readable medium 750.

FIG. 17 is a data flow diagram that depicts the operation of one illustrative embodiment of a network connection analysis system. In operation, the network connection analysis system receives a command 721. According to one alternative embodiment, the command 721 is received from an external source. According to one illustrative embodiment, the command comprises network connection parameters indicative of a connection to be monitored. According to one exemplary use case, the network connection parameters comprise a TCP protocol designation, two IP addresses, and two port numbers as taught herein (i.e. a 4-tuple).

The command 721 is received, according to one alternative embodiment, by the command interface 719 and is forwarded to the processor 700 by way of the system bus 740. The network connection characterization instruction sequence (or module) 775, when executed by the processor 700, minimally causes the processor 700 to analyze the command 721. Through this process, the processor 700 extracts from the command 721 at least one of a protocol identifier, a source address, a source port, a destination address and a destination port. Any or all of these parameters are stored in memory 705.

As the processor 700 continues to execute the network connection characterization module 775, it issues a request for connection states. According to one alternative embodiment, the network connection characterization instruction sequence 775 includes a state variable information receiver module 780. In this alternative embodiment, the processor 700 receives state information by executing the state variable information receiver module 780, which minimally causes the processor to convey to a protocol engine 430 a request 850 that includes at least one of the protocol identifier, the source address, the source port, the destination address and the destination port stored in the memory 705. In response to this request 850, the protocol engine 825 included in the an operating system 820 provides a state variable 855 for the associated network connection. This can be accomplished in a number of ways. For example, the state variables, according to one alternative embodiment, are conveyed directly from the protocol engine 825 to the state variable information receiver module 780. According to an alternative example embodiment, the protocol engine 825 provides a reference (e.g. a pointer) to a state variable stored in the memory 705. In this case, the state variable receiver module 780 retrieves 860 the state variable directly from the memory 705 using the reference.

As the processor 700 continues to execute the network connection characterization module 775, it monitors the value of a state variable received from the protocol engine 825 to determine if a connection has been initiated. According to one alternative embodiment wherein the processor 700 monitors the value of a TCP/IP state variable called “STATE”. According to yet another alternative embodiment, the processor 700, as it continues to execute the network connection characterization module 775, sets or clears a flag in memory 705 according to the state of a network connection. Once a connection is initiated, the processor 700 stores state variable information. According to one example embodiment, the processor 700 is minimally caused to store state information by conveying 870 the state information to the operating system 820 in reliance that the operating system 820 will store the state information on the computer readable medium 750. According to one embodiment, the state information is indexed on the computer readable medium 750 according to connection parameters (e.g. a 4-tuple originally used to specify a connection for monitoring). According to yet another alternative embodiment, the network connection characterization module 775 minimally causes the processor 700 to retrieve and store state information for a connection on a periodic basis.

According to one illustrative embodiment, the processor 700 is capable of receiving an off-line analysis request command. In response, the processor 700 executes the off-line connection analysis module 785. When executed by the processor 700, the off-line connection analysis module 785 minimally causes the processor 700 to perform an off-line analysis of a network connection when a network connection has been terminated. Typically, the off-line analysis request command includes connection parameters indicative of a connection that is to be the subject of the analysis. Based on these parameters, the processor 700 senses when the connection terminates by monitoring a state variable according to the teachings of the present method. According to one example embodiment, the off-line connection analysis module 785 minimally causes the processor 700 to examine the state of a flag stored in memory 705. This flag is indicative of the state of a connection defined by the parameters. When the connection terminates, the off-line connection analysis module 785 minimally causes the processor to retrieve state information stored in the computer readable medium 750 and then create a history of the network connection according to the state variable information associated with the connection.

The off-line connection analysis instruction sequence 785, according to one alternative embodiment, includes a network connection profile module 790 as depicted in FIG. 16. Also as depicted in FIG. 16, one alterative embodiment of the network connection profile module 790 includes an exceptional event detection module 795. Yet another alternative embodiment of the network connection profile module 790 includes an exceptional event analysis module 800. When executed by the processor 700, the network connection profile module 790 minimally causes the processor 700 to generate a report. One form of a report is described supra with the support of FIG. 13. According to one alternative embodiment, the network connection profile module 790 minimally causes the processor 700 to retrieve 880 state variables for the connection. According to one alternative embodiment, this is accomplished by way of a data request command 885 issued to the operating system 820. In response, the operating system 820 retrieves a state variable for a particular connection from the computer readable medium 750. This, according to one alternative embodiment, is accomplished by accessing data on the computer readable medium 750 that is indexed using the connection parameters. The state variable is then forwarded 880 to the off-line connection analysis module 785 by the operating system 820.

The processor 700 further creates a network connection profile, creates a history of the network connection profile and stored this in memory 705. The processor 700 then loads and executes the exceptional event detection instruction sequence 795 that minimally causes the processor 700 to analyze the network connection profile in memory 705 and to detect any events that are considered exceptional. According to one illustrative embodiment, when an exceptional event is detected, the processor 700, operating under the control of the exceptional event detection instruction sequence 795, loads the exceptional event analysis instruction sequence 800. Executing the exceptional event detection instruction sequence 795 minimally causes the processor 700 to analyze the exceptional event and to place the results of the analysis in memory 705. According to one illustrative embodiment, the results of the analysis comprise a chronological listing of all state variables for a few seconds of time before and after the exceptional event. When the exceptional event analysis has been completed, the processor 700 continues to execute the off-line connection analysis module 785 in order to generate an analysis report. This is done by accessing the results of the exceptional event detection and analysis in memory 705 and by creating a report according to the results. One example of such a report is illustrated in FIG. 13. According to one alternative example embodiment, the off-line connection analysis module 785 further minimally causes the processor 700 to communicate the report to a printer driver 725 that causes the report to be printed on a printer 730.

According to one example alternative embodiment, the external command 721 comprises a real-time analysis request. According to this embodiment, monitoring of a connection proceeds in a manner similar to that described supra. When the processor 700 recognizes a real-time analysis request, it executes the real-time connection analysis module 805 that minimally causes the processor 700 to retrieves one or more state variables from the computer readable medium 705 for a connection while the connection continues. The real-time connection analysis module 805 causes the processor 700 to direct the state variables to the display driver 715. According to one alternative embodiment, the processor 700 creates a dynamic profile by executing a dynamic profile generation module 810 (shown in FIG. 16). The dynamic profile generation module 810, when executed by the processor 700, minimally causes the processor 700 to create a dynamic profile of the network connection using the retrieved state variable information and direct the dynamic profile to the display driver 715. According to one alternative embodiment, the real-time connection analysis module 805 causes the processor 700 to generate a sliding window presentation of state variables observed during the connection. The state variables to be presented, according to one alternative embodiment, are incorporated into the real-time analysis request command. According to one example embodiment, the dynamic profile generation instruction sequence 810 further minimally causes the processor 700 to generate a similar sliding window presentation using the display driver 715. The display driver 710, according to one embodiment, comprises a display memory wherein the processor 700 generates a representation of a display to be presented on a display device 720. The display driver 715 is capable of generating a display signal 717 compatible with the input of a display device 720 (e.g. a cathode ray tube monitor).

The functional processes (and their corresponding instruction sequences) described thus far that enable characterization of a network connection are, according to one embodiment, imparted onto computer readable medium. Examples of such media include, but are not limited to, random access memory, read-only memory (ROM), CD ROM, floppy disks, and magnetic tape. This computer readable media, which alone or in combination can constitute a stand-alone product, can be used to convert a general-purpose computing platform into a device for migrating file locks from one server to another according to the techniques and teachings presented herein.

While the present method, network connection analysis unit, network connection analysis system, and computer-readable medium have been described in terms of several alternative methods and embodiments, it is contemplated that alternatives, modifications, permutations, and equivalents thereof are to be included in the scope of the appended claims.

1. A method for characterizing a network connection comprising:
receiving parameters that specify a network connection;
receiving state variable information pertaining to the network connection according to the parameters;
sensing when the network connection is initiated according to the received state variable information; and
storing the state variable information.

2. The method of claim 1 wherein receiving state variable information comprises:
conveying to a protocol engine a parameter including at least one of a protocol identifier, a source address, a source port, a destination address and a destination port; and
receiving from the protocol engine a state variable for the network connection according to the parameter.

3. The method of claim 1 wherein sensing when the network connection is initiated comprises monitoring the value of a state variable indicative of the connection state of the connection.

4. The method of claim 1 wherein sensing when the network connection is initiated comprises monitoring the value of a TCP/IP state variable called “STATE”.

5. The method of claim 1 further comprising:
sensing when the network connection terminates according to the state variable information;
retrieving stored state variable information according to the network connection after the network connection terminates; and
creating a history of the network connection according to the state variable information.

6. The method of claim 5 wherein creating a history of the network connection comprises:
developing a network connection profile from the state variable information; and
creating a history of the network connection profile.

7. The method of claim 6 wherein creating a history of the network connection profile comprises detecting an exceptional event.

8. The method of claim 7 further comprising analyzing the exceptional event.

9. The method of claim 1 further comprising:
retrieving the state variable information while the network connection continues; and
making the state variable information available on a periodic basis.

10. The method of claim 9 further wherein making state variable information available comprises:
creating a dynamic profile of the network connection according to the state variable information; and
making the dynamic profile available on a periodic basis.

11. A network connection analysis unit capable of characterizing a network connection, said network connection analysis unit comprising:
supervisor comprising:
command register capable of receiving parameters that specify a network connection, and
source address register capable of receiving an address referencing the location of state variables in a state memory;
supervisory controller capable of:
directing a state variable request to a protocol engine according to the parameters;
sensing when the network connection is initiated by monitoring a location in the state memory as referenced by the contents of the source address register, and
first computer readable medium controller capable of directing a plurality of state variables from the state memory to a computer readable medium when the network connection is initiated.

12. The network connection analysis unit of claim 11 wherein the command register generates parameters including at least one of a protocol identifier, a source address, a source port, a destination address and a destination port and wherein the controller is further capable of loading into the source address register a memory reference received from a protocol engine.

13. The network connection analysis unit of claim 11 wherein the state memory referenced by the source address register contains an indictor of activity of the network connection.

14. The network connection analysis unit of claim 11 wherein the state memory referenced by the source address register contains a TCP/IP state variable called “STATE”.

15. The network connection analysis unit of claim 11 further comprising an off-line connection analyzer comprising:
off-line command register capable of receiving an off-line analysis request that includes a connection specifier;
off-line computer readable medium controller capable of retrieving state variables from a computer readable medium according to the connection specifier;
format table capable of converting the state variables into a print stream;
off-line analysis controller capable of causing the second computer readable medium controller to retrieve state variables and further capable of directing the retrieved state variables to the format table.

16. The network connection analysis unit of claim 15 wherein format table includes a profile description that correlates one or more state variables to a connection profile.

17. The network connection analysis unit of claim 16 wherein the off-line connection analyzer further comprises an exceptional event detector capable of detecting an exceptional event.

18. The network connection analysis unit of claim 17 wherein the exceptional event detector is capable of analyzing the exceptional event.

19. The network connection analysis unit of claim 11 further comprising a real-time connection analyzer comprising:
real-time command register capable of receiving an real-line analysis request that includes a connection specifier;
real-time computer readable medium controller capable of retrieving state variables from a computer readable medium according to the connection specifier; and
display subsystem capable of generating a display signal according to the retrieved state variables.

20. The network connection analysis unit of claim 19 wherein the display subsystem comprises:
profile generator capable of creating a profile of a network connection.

21. A network connection analysis system comprising:
memory capable of storing instructions;
processor capable of executing instructions stored in the memory; and
network connection characterization instruction sequence that, when executed by the processor, minimally causes the processor to:
receive parameters that specify a network connection;
receive state variable information pertaining to the network connection according to the parameters;
sense when the network connection is initiated according to the received state variable information; and
store the state variable information.

22. The network connection analysis system of claim 21 wherein the network connection characterization instruction sequence includes a state variable information receiver instruction sequence that, when executed by the processor, causes the processor to receive state variable information by minimally causing the processor to:
convey to a protocol engine a parameter including at least one of a protocol identifier, a source address, a source port, a destination address and a destination port; and
receive from the protocol engine state variables for the network connection according to the parameter.

23. The network connection analysis system of claim 21 wherein the network connection characterization instruction sequence causes the processor to sense when the network connection has been initiated by minimally causing the processor to monitor the value of a state variable that is indicative of the connection state of the connection.

24. The network connection analysis system of claim 21 wherein the network connection characterization instruction sequence causes the processor to sense when the network connection has been initiated by minimally causing the processor to monitor the value of a TCP/IP state variable called “STATE”.

25. The network connection analysis system of claim 21 further comprising an off-line connection analysis instruction sequence that, when executed by the processor, minimally causes the processor to:
sense when the network connection terminates according to the state variable information;
retrieve stored state variable information after the network connection terminates; and
create a history of the network connection according to the state variable information.

26. The network connection analysis system of claim 25 wherein the off-line connection analysis instruction sequence comprises a network connection profile creation instruction sequence that, when executed by the processor, causes the processor to create a history by minimally causing the processor to:
develop a network connection profile from the state variable information; and
create a history of the network connection profile.

27. The network connection analysis system of claim 26 wherein the network connection profile creation instruction sequence comprises an exceptional event detection instruction sequence that, when executed by the processor, minimally causes the processor to detect an exceptional event.

28. The network connection analysis system of claim 27 wherein the network connection profile creation instruction sequence further comprises an exceptional event analysis instruction sequence that, when executed by the processor, minimally causes the processor to analyze the exceptional event.

29. The network connection analysis system of claim 21 further comprising:
display driver capable of generating a display signal; and
real-time connection analysis instruction sequence that, when executed by the processor, further minimally causes the processor to:
retrieve the state variable information while the network connection continues; and
direct the state information to the display driver.

30. The network connection analysis system of claim 29 wherein the real-time connection analysis instruction sequence comprises a dynamic profile generation instruction sequence that, when executed by the processor, minimally causes the processor to:
create a dynamic profile of the network connection according to the state variable information; and
direct the dynamic profile to the display driver.

31. A computer-readable medium having computer-executable functions for characterizing a network connection comprising:
network connection characterization instruction sequence that, when executed by a processor, minimally causes the processor to:
receive parameters that specify a network connection;
receive state variable information pertaining to the network connection according to the parameters;
sense when the network connection is initiated according to the received state variable information; and
store the state variable information.

32. The computer-readable medium of claim 31 wherein the network connection characterization instruction sequence includes a state variable information receiver instruction sequence that, when executed by a processor, causes the processor to receive state variable information by minimally causing the processor to:
convey to a protocol engine a parameter including at least one of a protocol identifier, a source address, a source port, a destination address and a destination port; and
receive from the protocol engine state variables for the network connection according to the parameter.

33. The network connection analysis system of claim 31 wherein the network connection characterization instruction sequence causes the processor to sense when the network connection has been initiated by minimally causing the processor to monitor the value of a state variable that is indicative of the connection state of the connection.

34. The network connection analysis system of claim 31 wherein the network connection characterization instruction sequence causes the processor to sense when the network connection has been initiated by minimally causing the processor to monitor the value of a TCP/IP state variable called “STATE”.

35. The computer-readable medium of claim 31 further comprising an off-line connection analysis instruction sequence that, when executed by a processor, minimally causes the processor to:
sense when the network connection terminates according to the state variable information;
retrieve stored state variable information after the network connection terminates; and
create a history of the network connection according to the state variable information.

36. The computer-readable medium of claim 35 wherein the off-line connection analysis instruction sequence comprises a network connection profile creation instruction sequence that, when executed by a processor, causes the processor to create a history by minimally causing the processor to:
develop a network connection profile from the state variable information; and
create a history of the network connection profile.

37. The computer-readable medium of claim 36 wherein the network connection history profile instruction sequence comprises an exceptional event detection instruction sequence that, when executed by a processor, minimally causes the processor to detect an exceptional event.

38. The computer-readable medium of claim 37 wherein the network connection profile creation instruction sequence further comprises an exceptional event analysis instruction sequence that, when executed by a processor, minimally causes the processor to analyze the exceptional event.

39. The computer-readable medium of claim 31 further comprising a real-time connection analysis instruction sequence that, when executed by a processor, further minimally causes the processor to:
retrieve the state variable information while the network connection continues; and
direct the state information to a display driver.

40. The computer-readable medium of claim 39 wherein the real-time connection analysis instruction sequence comprises a dynamic profile generation instruction sequence that, when executed by a processor, minimally causes the processor to:
create a dynamic profile of the network connection according to the state variable information; and
direct the dynamic profile to the display driver.

41. A network connection analysis apparatus comprising:
means for receiving state variable information pertaining to the network connection according to a set of received network parameters;
means for sensing initiation of the network connection according to the received state variable information; and
means for storing the state variable information.

42. The network connection analysis apparatus of claim 41 wherein the state variable information receiving means comprises:
means for conveying to a protocol engine a parameter including at least one of a protocol identifier, a source address, a source port, a destination address and a destination port; and
means for receiving from the protocol engine a state variable for the network connection according to the parameter.

43. The network connection analysis apparatus of claim 41 wherein the means for sensing initiation of the network connection comprise a means for monitoring the value of a state variable indicative of the connection state of a network connection.

44. The network connection analysis apparatus of claim 41 wherein the means for sensing initiation of the network connection comprise a means for monitoring the value of a TCP/IP state variable called “STATE”.

45. The network connection analysis apparatus of claim 41 further comprising:
means for sensing when the network connection terminates according to the state variable information;
means for retrieving stored state variable information according to the network connection after the network connection terminates; and
means for creating a history of the network connection according to the state variable information.

46. The network connection analysis apparatus of claim 45 wherein means for creating a history of the network connection comprises:
means for developing a network connection profile from the state variable information; and
means for creating a history of the network connection profile.

47. The network connection analysis apparatus of claim 46 wherein means for creating a history of the network connection profile comprises means for detecting an exceptional event.

48. The network connection analysis apparatus of claim 47 further comprising means for analyzing the exceptional event.

49. The network connection analysis apparatus of claim 41 further comprising:
means for retrieving the state variable information while the connection continues; and
means for making the state variable information available on a periodic basis.

50. The network connection analysis apparatus of claim 49 wherein means for making the state variable information available comprises:
means for creating a dynamic profile of the network connection according to the state variable information; and
means for making the dynamic profile available on a periodic basis.
